(19) United States
(12) Patent Application Publication
(10) Pub. No.: US 2010/0061836 A1
(43) Pub. Date: Mar. 11, 2010

(54) Process for producing a turbine blade or vane with an oxide on a metallic layer, use of such a turbine blade or vane, a turbine and a method for operating a turbine

(76) Inventor: Werner Stamm, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/517,585

(22) PCT Filed: Sep. 6, 2007
(86) PCT No.: PCT/EP2007/059337

§ 371 Date: Jun. 4, 2009

(30) Foreign Application Priority Data
Dec. 5, 2006 (EP) 06025146.9

(51) Int. Cl. F02C 7/12; C23C 8/16

(52) U.S. Cl. 415/1; 148/284; 415/177; 416/95

(57) ABSTRACT

A process for producing a component of a gas turbine having a substrate with a metallic layer is provided. The metallic layer is a MCrAlX layer which is treated at temperatures elevated above the operating temperature, by at least 50° C., so that the oxidation and corrosion behavior are improved. In particular a MCrAlX of the type, NiCoCrAlX is used.

### CROSS REFERENCE TO RELATED APPLICATIONS

This application is the US National Stage of International Application No. PCT/EP2007/059337, filed Sep. 6, 2007 and claims the benefit thereof. The International Application claims the benefits of European Patent Office application No. 06025146.9 EP filed Sep. 5, 2006, both of the applications are incorporated by reference herein in their entirety.

### FIELD OF INVENTION

The invention relates to a process for producing a turbine blade or vane with an oxidized metallic layer, to the use of such a turbine blade or vane, to a turbine and to a method for operating a turbine.

### BACKGROUND OF INVENTION

Turbine blades or vanes are provided with protective layers, e.g. consisting of MCrAlX, so as to be protected against corrosion and/or oxidation. These are metallic layers on which a protective oxide layer is formed.

The oxide layers which form are frequently insufficient for affording protection.

### SUMMARY OF INVENTION

Therefore, it is an object of the invention to overcome the problem mentioned above.

The object is achieved by means of a process as claimed in the claims, the use as claimed in the claims, a turbine as claimed in the claims and by means of a method for operating a turbine as claimed in the claims.

The dependent claims each list further advantageous measures which can advantageously be combined with one another.

The invention is explained below.

### BRIEF DESCRIPTION OF THE DRAWINGS

In the drawings:

FIG. 1 shows a layer system,

FIG. 2 shows a gas turbine,

FIG. 3 is a perspective view of a turbine blade or vane,

FIG. 4 is a perspective view of a combustion chamber, and

FIG. 5 shows a list of superalloys.

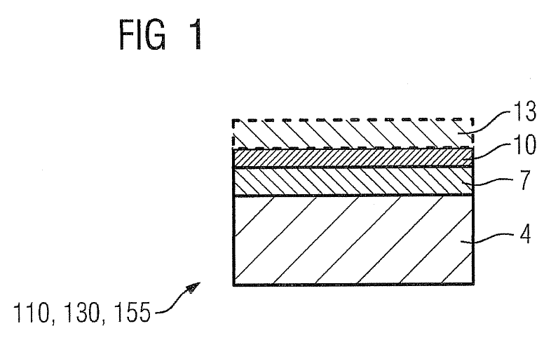

### DETAILED DESCRIPTION OF INVENTION

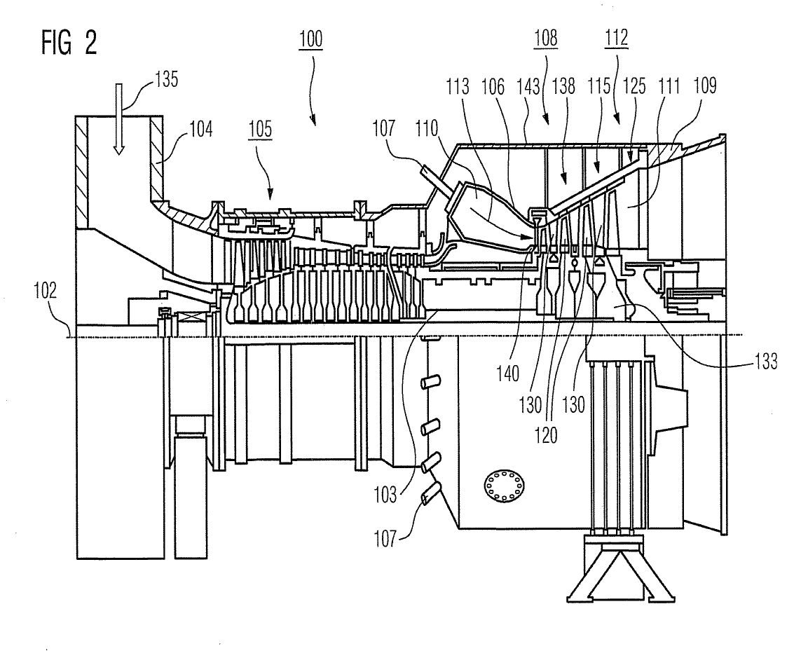

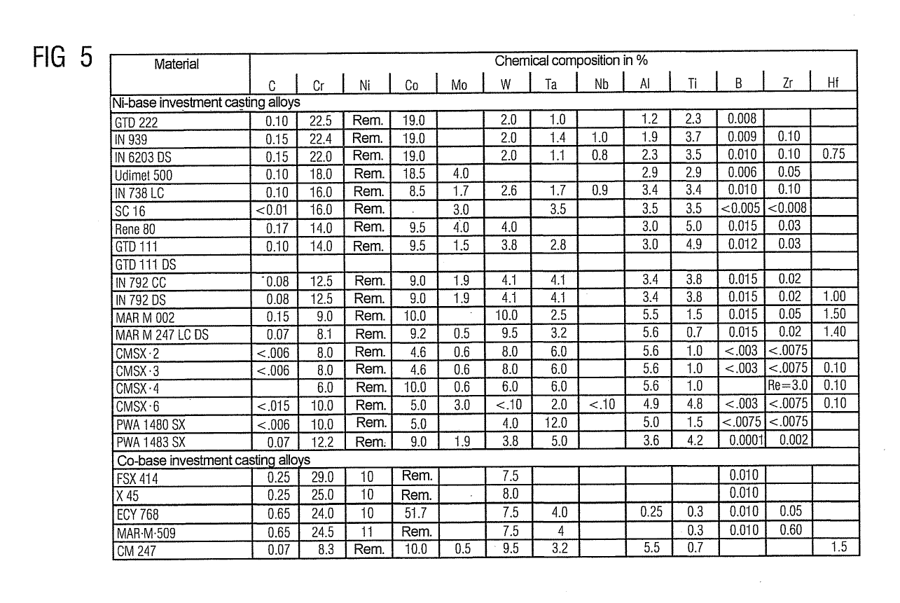

A metallic protective layer 7 is applied to a metallic substrate 4 which, in particular in the case of components for gas turbines for aircraft, for compressors or for gas turbines 100 (FIG. 2) for generating power, represents a nickel-base or cobalt-base superalloy (FIG. 5). Said metallic protective layer 7 is, in particular, an alloy of the MCrAlX type.

A turbine blade or vane 120, 130 coated in this way is then installed in the gas turbine 100 of an aircraft or for stationary use, and this oxidizes during use. The temperatures to which the turbine blade or vane 120, 130 is exposed when used in a third or fourth stage of a gas turbine 100 are preferably from 900° C. to 950° C.

In the turbine region, the turbine 100 preferably has four stages of guide vanes 130 and rotor blades 120, wherein a ceramic thermal barrier coating 13 is applied to the turbine blades or vanes 120, 130 at least in the first row, i.e. the guide vanes 130 and the rotor blades 120. In particular, the turbine 100 has only four stages.

According to the invention, the metallic layer 7 is oxidized before use, to be precise at temperatures which are in particular at least 50° C., preferably 50° C., above the operating temperature, i.e. in this case at 950° C. to 1000° C. In the case of the MCrAlX layers, the use of elevated temperatures produces stable α aluminum oxide which would not form at lower operating temperatures. The α aluminum oxide layer 10 formed in this process displays the best antioxidation protection. Once an α Al₂O₃ layer forms, this further even at lower temperatures.

The oxidation of the metallic layer 7 is preferably carried out under a reduced oxygen atmosphere.

For this purpose, the oxidation may preferably take place under nitrogen, argon or helium or under a shielding gas mixture.

It is likewise possible for a specific water vapor pressure to be set in order to achieve the desired aluminum oxide phase.

The oxygen partial pressure is preferably from 10⁻⁷ bar to 10⁻¹⁵ bar.

Even if this metallic layer 7 is not used as an overlay layer, as in the case of the third or fourth stage of a stationary gas turbine 100, the process may also be used when an outer ceramic layer 13 (for the first and/or second row of blades or vanes) is applied, when the temperatures to which the metallic layer 7 beneath a ceramic thermal barrier coating 13 is exposed are lower than the temperature required to form the desired oxide.

The process is preferably carried out with the following MCrAlX coatings (in this case, X═Y):
Co-(27-29)Ni-(23-25)Cr-(9-11)Al-(0.5-0.7)Y,
in particular Co-28Ni-24Cr-10Al-0.6Y,
in particular with silicon (Si),
or
Ni-(11-13)Co-(20-22)Cr-(10-12)Al-(0.3-0.5)Y-(1.5-2.5)Re,
in particular Ni-12Co-21Cr-11Al-0.4Y-2Re,
or
Ni-(24-26)Co-(16-18)Cr-(9-11)Al-(0.3-0.5)Y-(1.0-2.0)Re,
in particular Ni-25Co-17Cr-10Al-0.4Y-1.5Re,
or
Co-(29-31)Ni-(27-29)Cr-(7-9)Al-(0.5-0.7)Y-(0.6-0.8)Si,
in particular Co-30Ni-28Cr-8Al-0.6Y-0.7Si.

The layer 7 preferably consists of one of the alloys mentioned above.

FIG. 2 shows by way of example a partial longitudinal section through a gas turbine 100.

In its interior, the gas turbine 100 has a rotor 103 which is mounted such that it can rotate about an axis of rotation 102, has a shaft 101, and is also referred to as the turbine rotor.

An intake casing 104, a compressor 105, a for example tonic combustion chamber 110, in particular an annular combustion chamber, with a plurality of coaxially arranged burners 107, a turbine 108 and the exhaust gas casing 109 follow one another along the rotor 103.

The annular combustion chamber 110 is in communication with a for example annular hot gas duct 111. There, by way of example, four successive turbine stages 112 form the turbine 108.

Each turbine stage 112 is formed for example from two blade rings. As seen in the direction of flow of a working medium 113, a guide vane row 115 is followed in the hot gas duct 111 by a row 125 formed from rotor blades 120.

The guide vanes 130 are secured to an inner casing 138 of a stator 143, whereas the rotor blades 120 belonging to a row 125 are arranged on the rotor 103, for example by means of a turbine disk 133.

A generator (not shown) is coupled to the rotor 103.

While the gas turbine 100 is operating, air 135 is drawn in through the intake casing 104 and compressed by the compressor 105. The compressed air provided at the turbine end of the compressor 105 is passed to the burners 107, where it is mixed with a fuel. The mixture is then burnt in the combustion chamber 110, forming the working medium 113. From there, the working medium 113 flows along the hot gas duct 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they can be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110.

Superalloys of this type are known for example from EP 1 204 776 B1, EP 1 306 454, EP 1 319 729 A1, WO 99/67435 or WO 00/44949; these documents faun part of the disclosure with regard to the chemical composition of the alloys.

The guide vane 130 has a guide vane root (not shown here) facing the inner casing 138 of the turbine 108 and a guide vane head at the opposite end from the guide vane root. The guide vane head faces the rotor 103 and is fixed to a securing ring 140 of the stator 143.

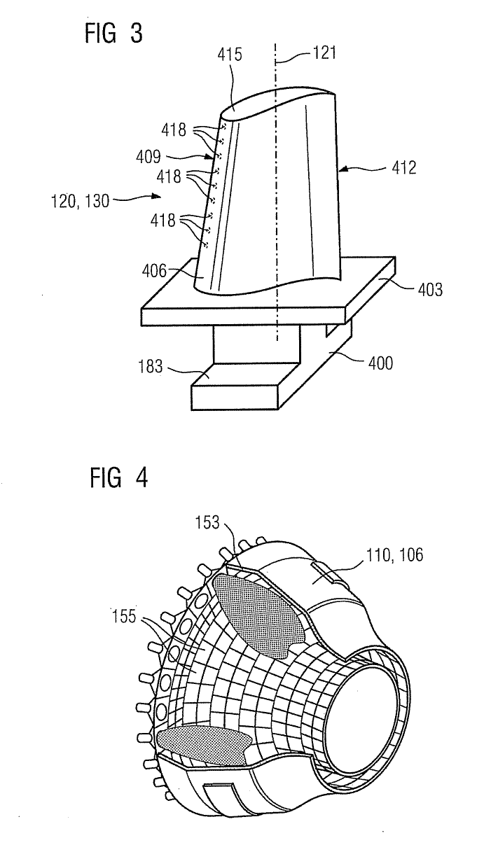

FIG. 3 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403, a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloy.

The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to four) the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1; these documents form part of the disclosure with regard to the solidification process.

The blades or vanes 120, 130 may likewise have coatings protecting against corrosion or oxidation, for example (MCrAlX; M is at least one element selected from the group consisting of iron (Fe), cobalt (Co), nickel (Ni), X is an active element and stands for yttrium (Y) and/or silicon and/or at least one of the rare earth elements, or hafnium (Hf)). Alloys of this type are known from EP 0 486 489 B1, EP 0 786 017 B1, EP 0 412 397 B1 or EP 1 306 454 A1, which are intended to form part of this disclosure with regard to the chemical composition of the alloy.

The density is preferably 95% of the theoretical density.

A protective aluminum oxide layer (TGO=thermally grown oxide layer) is formed on the MCrAlX layer (as an interlayer or as the outermost layer), preferably by means of the process according to the invention.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by means of suitable coating processes, such as for example electron beam physical vapor deposition (EB-PVD).

Other coating processes are conceivable, for example atmospheric plasma spraying (APS), LPPS, VPS or CVD. The thermal barrier coating may have grains that are porous and/or include micro-cracks or macro-cracks in order to improve the resistance to thermal shocks. Therefore, the thermal barrier coating is preferably more porous than the MCrAlX layer.

The blade or vane 120, 130 may be hollow or solid in form.

If the blade or vane 120, 130 is to be cooled, it is hollow and may also have film-cooling holes 418 (indicated by dashed lines).

FIG. 4 shows a combustion chamber 110 of the gas turbine 100. The combustion chamber 110 is configured, for example, as what is known as an annular combustion chamber, in which a multiplicity of burners 107, which generate flames 156 and are arranged circumferentially around an axis of rotation 102, open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

A cooling system may also be provided for the heat shield elements 155 and/or their holding elements, on account of the high temperatures in the interior of the combustion chamber 110. The heat shield elements 155 are then for example hollow and may also have cooling holes (not shown) which open out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to those used for the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one of the rare earth elements, or hafnium (Hf). Alloys of this type are known from EP 0 486 489 B1, EP 0 786 017 B1, EP 0 412 397 B1 or EP 1 306 454 A1, which are intended to form part of this disclosure with regard to the chemical composition of the alloy. This protective layer is treated according to the invention.

A for example ceramic thermal barrier coating, consisting for example of ZrO₂, Y₂O₃—ZrO₂, i.e. unstabilized, partially stabilized or fully stabilized by yttrium oxide and/or calcium oxide and/or magnesium oxide, may also be present on the MCrAlX.

Columnar grains are produced in the thermal barrier coating by suitable coating processes, such as for example electron beam physical vapor deposition (EB-PVD).

Other coating processes are conceivable, for example atmospheric plasma spraying (APS), LPPS, VPS or CVD. The thermal barrier coating may have grains that are porous and/or include micro-cracks or macro-cracks in order to improve the resistance to thermal shocks.

Refurbishment means that after they have been used, protective layers may have to be removed from turbine blades or vanes 120, 130, heat shield elements 155 (e.g. by sand-blasting). Then, the corrosion and/or oxidation layers and products are removed. If appropriate, cracks in the turbine blade or vane 120, 130 or the heat shield element 155 are also repaired. This is followed by recoating of the turbine blades or vanes 120, 130, heat shield elements 155, after which the turbine blades or vanes 120, 130 or the heat shield elements 155 can be reused.

1-22. (canceled)

23. A method for producing a component of a gas turbine having a substrate with a metallic layer, comprising:
oxidizing the metallic layer at a temperature which is 50° C. more than an operating temperature of the metallic layer in the gas turbine,
wherein the metallic layer forms an oxide layer.

24. The method as claimed in claim 23, wherein an oxide formation temperature is in a range from 950° C. to 1150° C.

25. The method as claimed in claim 23, wherein the oxide formation temperature is 1000° C.

26. The method as claimed in claim 23, wherein the metallic layer consists of NiCoCrAlX which is a MCrAlX type alloy.

27. The method as claimed in claim 26, wherein the NiCoCrAlX alloy has a composition comprising in a weight percentage,
Co-(27-29)Ni-(23-25)Cr-(9-11)Al-(0.5-0.7)Y.

28. The method as claimed in claim 26, wherein the NiCoCrAlX alloy has the composition comprising in a weight percentage,
Ni-(11-13)Co-(20-22)Cr-(10-12)Al-(0.3-0.5)Y-(1.5-2.5)Re.

29. The method as claimed in claim 26, wherein the NiCoCrAlX alloy has the composition comprising in the weight percentage,
Ni-(24-26)Co-(16-18)Cr-(9-11)Al-(0.3-0.5)Y-(1.0-2.0)Re.

30. The process as claimed in claim 26, wherein the NiCoCrAlY alloy has the composition comprising in the weight percentage,
Co-(29-31)Ni-(27-29)Cr-(7-9)Al-(0.5-0.7)Y-(0.6-0.8)Si.

31. The method as claimed in claim 23, wherein a ceramic thermal barrier coating is applied to the metallic layer.

32. The method as claimed in claim 23, wherein the ceramic thermal barrier coating is not applied to the metallic layer.

33. The method as claimed in claim 26, wherein an oxidation of the metallic layer is carried out in vacuo or at an oxygen partial pressure significantly lower than the oxygen partial pressure in air.

34. The method as claimed in claim 33,
wherein the oxidation is carried out under a shielding gas, and
wherein the shielding gas is nitrogen, argon and/or helium.

35. The method as claimed in claim 33, wherein a water vapor is used during the oxidation.

36. The process as claimed in claim 33, wherein the oxygen partial pressure is between 10⁻⁷ bar and 10⁻¹⁵ bar.

37. A turbine, comprising:
a compressor;
a combustion chamber;
a turbine region; and
a plurality of components having a substrate with a metallic layer wherein the metallic layer can form an oxidized layer,
wherein a thermal barrier coating applied on the plurality of turbine blades or the plurality of turbine vanes of a third stage and a fourth stage of the turbine region is oxidized before being installed, and
wherein the plurality of components are a plurality of turbine blades or a plurality of turbine vanes.

38. The turbine as claimed in claim 37, further comprising four rows of turbine blades or four rows of turbine vanes in the turbine region,
wherein a row of turbine blades or a row of turbine vanes comprise a disk with a plurality of guide vanes and a disk with rotor blades.

39. The turbine as claimed in claim 37, wherein a first row of the plurality of turbine blades or a first row of the plurality of vanes have a ceramic thermal barrier coating.

40. The turbine as claimed in claim 37, wherein the plurality of blades or the plurality of vanes of the third stage and the fourth stage do not have the ceramic thermal barrier coating.

41. A method for operating a turbine, comprising:
having a plurality of turbine blades or a plurality of vanes which have an oxidized metallic layer;
producing the plurality of turbine blades or a plurality of vanes by oxidizing the metallic layer at a temperature which is 50° C. more than an operating temperature of the metallic layer in the turbine, and
regulating an operating temperature of the turbine blade or the turbine vane so that the operating temperature is at least 50° C. lower than a temperature at which the oxidized metallic layer was formed on the turbine blade or the turbine vane.

42. The method as claimed in claim 41, wherein the plurality of turbine blades or the plurality of vanes having the oxidized metallic layer are used in a third stage and/or a fourth stage of a turbine.
